(19) United States
(12) Patent Application Publication
(10) Pub. No.: US 2026/0064465 A1
(43) Pub. Date: Mar. 5, 2026

(54) ACTIVE COOLING OF DATA PROCESSING SYSTM USING EMBEDDED CONTROLLER IN AN ADVANCED REDUCED INSTRUCTION SET COMPUTER MACHINES (ARM) ARCHITECTURE

(71) Applicant: Dell Products L.P., Round Rock, TX (US)

(72) Inventors: ADOLFO SANDOR MONTERO, Pflugerville, TX (US); SURAJ M. VARMA, Portland, OR (US)

(21) Appl. No.: 18/820,586

(22) Filed: Aug. 30, 2024

(51) Int. Cl. G06F 9/48; G06F 1/20; G06F 9/4401

(52) U.S. Cl. CPC G06F 9/4893; G06F 1/20; G06F 9/4401

(57) ABSTRACT

Methods and systems for managing cooling of a data processing system. In particular, active cooling using a fan controlled by an embedded controller is provided in a data processing system having a processor installed on a system on a chip (SoC) that is originally only capable of providing passive cooling to the data processing system through throttling of the processor. The system temperature of the data processing system may be communicated from the SoC to the embedded controller using an application digital signal processor (ADSP) configured to communicate with the embedded controller using an inter-integrated circuit (I2C)/improved inter-integrated circuit (I3C) interface.

### FIELD

Embodiments disclosed herein relate generally to managing data processing systems. More particularly, embodiments disclosed herein relate to systems and methods for managing cooling of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with one or more embodiments.

FIG. 2A shows a block diagram illustrating an example data processing system in accordance with one or more embodiments.

FIG. 2B shows a block diagram illustrating another example of a data processing system in accordance with an embodiment.

FIG. 3 shows a data flow diagram in accordance with one or more embodiments.

FIG. 4 shows a flowchart in accordance with one or more embodiments.

FIG. 5 shows a block diagram illustrating a data processing system in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing cooling of a data processing system. For example, data processing system may be cooled passively using passive cooling techniques (e.g., through throttling of the central processing unit (CPU), application management, or the like where a physical fan is not involved in the cooling process) (also referred to herein as “passive cooling”) or may be cooled actively using active cooling techniques (e.g., using one or more physical fans installed within the data processing system) (also referred to herein as “active cooling”).

System on a chip (SoC) devices (e.g., portable computing devices such as smartphones, tablet computers, or the like) utilize a thermal architecture that is only capable of providing passive cooling through throttling of a processor installed on an SoC integrated circuit (SoC IC) (also referred to herein as just “SoC”) installed within these SoC devices. The SoC IC may be, for example, the main processing chip designed to be installed in a portable computing device (e.g., smartphones, tablets, or the like) having housings with limited internal space/capacity that generally do not allow for installation of a motorized fan for blowing warm and/or hot air out of the housing. Examples of such SoCs may be, but are not limited to: the Apple™ A series chips, the Qualcomm Snapdragon® series chips, or the like.

Furthermore, in such SoC devices, the thermal sensors (e.g., thermistors or the like) that measure the system temperature of these devices are directly connected (e.g., soldered) to the SoC as part of an all-in-one-package. In particular, the SoC may include any number of power management integrated circuits (PMICs) (also referred to herein as a “power management circuit”) to which these thermal sensors are directly connected. This creates an issue when users of such SoC devices wish to user other/new components (e.g., an embedded controller or the like separate from the SoC) for thermal management of these SoC devices because: (i) re-wiring (e.g., re-soldering) the connections (e.g., on a printed circuit board (PCB) designed for the SoC) is a complicated and costly task; and (ii) the only other existing alternative to re-wiring is to physically duplicate the existing thermal sensors and connect the duplicated sensors to the other/new components taking over the thermal management of the system.

Even further, throttling in such SoC devices is performed using operating system (OS) based drivers that are only available when an OS of these SoC devices is fully operational (e.g., fully started up). Thus, when these SoC devices are still in a pre-boot stage (e.g., when the OS is being started up and not yet fully operational), no form of cooling is available to cool these SoC devices.

Even with such limitations, the SoCs of such SoC devices are (e.g., computational-wise) very powerful and highly sought out to be used in other devices and/or systems. For example, users may wish to use these SoCs (originally designed for SoC devices) in other computing devices with much larger housings (e.g., a desktop computer, a laptop computer, or the like) capable of accommodating moving fans to provide active cooling. However, because these SoCs are not originally designed to be able to provide active cooling, there are many challenges associated with combining such SoCs (adapted from a solely passive cooling thermal architecture) with components (e.g., fans, embedded controllers, or the like) from an active cooling thermal architecture.

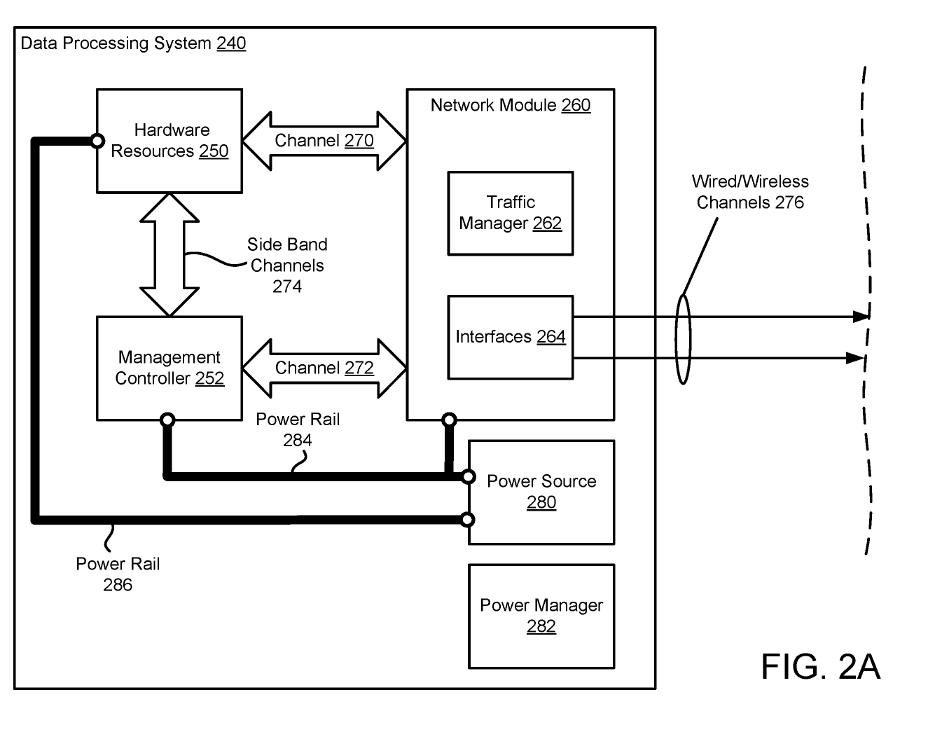

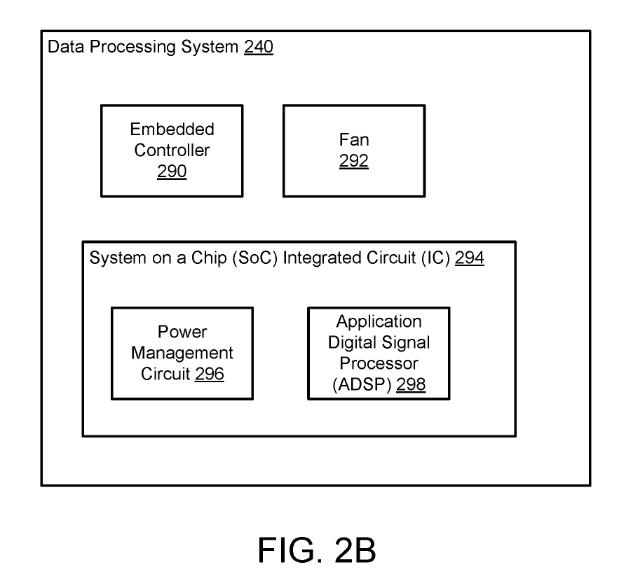

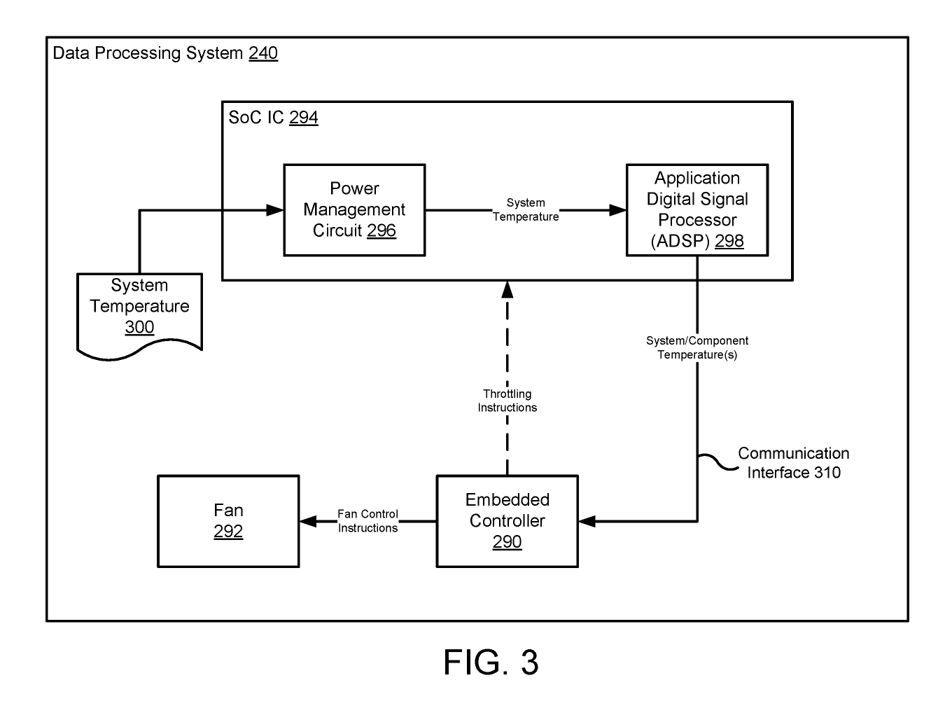

To overcome the above-discussed challenges and limitations, the inventors have provided, as part of one or more embodiments disclosed herein, mechanisms and components that would allow such SoCs that were originally designed to provide only passive cooling to also be able to provide active cooling (e.g., using fans controlled by embedded controllers, or the like). These mechanisms and components of one or more embodiments are discussed in more detail below in reference to FIGS. 2B and 3.

Additionally, because these embedded controllers do not rely on the OS hosted by the SoC for their operation and functionalities (e.g., operate independently from a processor of the SoC), cooling of these data processing systems with such hybrid thermal architectures (namely, a hybrid thermal architecture that combines an SoC originally designed to provide only passive cooling with fans controlled by an embedded controller separate from the SoC) would advantageously be available even when these data processing systems are at a pre-boot stage before the OS is fully started up and operational.

As a result, embodiments disclosed herein directly provides an improvement to thermal management technology in data processing systems (e.g., computing devices) having such hybrid thermal architectures. Additionally, by providing more versatile thermal management and cooling options, embodiments disclosed herein also improve not only the operations of such data processing systems having such hybrid thermal architectures but also the computer functionalities (e.g., preventing overheating during normal operation and pre-boot or the like) of such data processing systems.

In an embodiment, a computer-implemented method for providing active cooling using a fan controlled by an embedded controller in a data processing system having a processor installed on a system on a chip (SoC) that is originally only capable of providing passive cooling to the data processing system through throttling of the processor is provided. The method may include: obtaining, by a power management circuit of the SoC, system temperature of the data processing system, the power management circuit being incapable of communicating directly with the embedded controller; obtaining, by an application digital signal processor (ADSP) of the SoC, the system temperature from the power management circuit; providing, by the ADSP, the system temperature to the embedded controller via an inter-integrated circuit (I2C)/improved inter-integrated circuit (I3C) interface; and providing, by the embedded controller, active cooling for the data processing system by controlling the fan based on the system temperature, the embedded controller being incapable of obtaining the system temperature without aid from the ADSP.

The data processing system comprises one or more thermal sensors that measure the system temperature, and, among all components making up the data processing system, only the power management circuit is in connection and able to directly receive the system temperature measured by the one or more thermal sensors.

Among all of the components making up the data processing system, only the ADSP is able to provide the system temperature to the embedded controller.

Among all of the components making up the data processing system, only the ADSP is able to directly retrieve the system temperature from the power management circuit, the power management circuit being a power management integrated circuit (PMIC) installed on the SoC.

The SoC is adapted from a portable computing device not designed to include the embedded controller and the fan.

The portable computing device being a mobile phone or a tablet computer without a capacity to include the fan and the embedded controller, and the SoC comprises an advanced reduced instruction set computer machines (ARM) based processor as the processor.

The method may further include: determining, during a startup process of the data processing system and while the embedded controller is already providing the active cooling using the fan, that the system temperature is still above a predetermined threshold; and causing, by the embedded controller and in response to the determination, throttling of the processor to also provide the passive cooling in addition to providing the active cooling using the fan, the throttling being a system level throttling and provided when operating system (OS) level throttling is not available during the startup process when the OS has not yet completed booting up.

A non-transitory media may include instructions that when executed by a processor cause the computer-implemented method to be performed.

The data processing system may include the non-transitory media and a processor, and may perform the computer-implemented method when the computer instructions are executed by the processor.

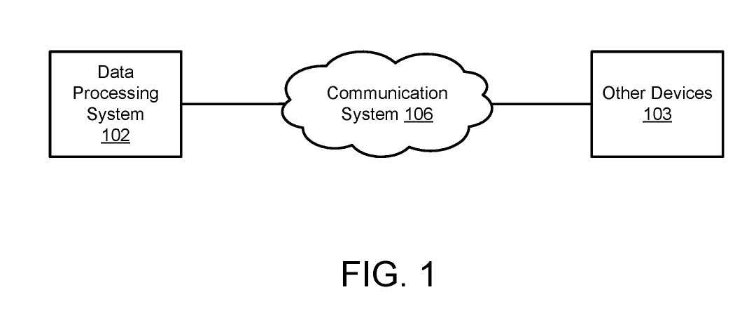

Turning to FIG. 1, a block diagram illustrating a distributed system in accordance with an embodiment is shown. The (distributed) system shown in FIG. 1 may provide computer-implemented services. The computer-implemented services may include any type and quantity of services including, for example data services (e.g., data storage, access and/or control services), communication services (e.g., instant messaging services, video-conferencing services), and/or any other type of service that may be implemented with a computing device.

The computer-implemented services may be provided by one or more components of the system of FIG. 1. For example, data processing system 102 may be implemented as any type of computing device (e.g., desktop computers, mobile phones, tablets, laptops, or the like) that may provide computer-implemented services. For example, the computer-implemented services may include data storage services, instant messaging services, database services, and/or any other type of service that may be implemented with a computing device.

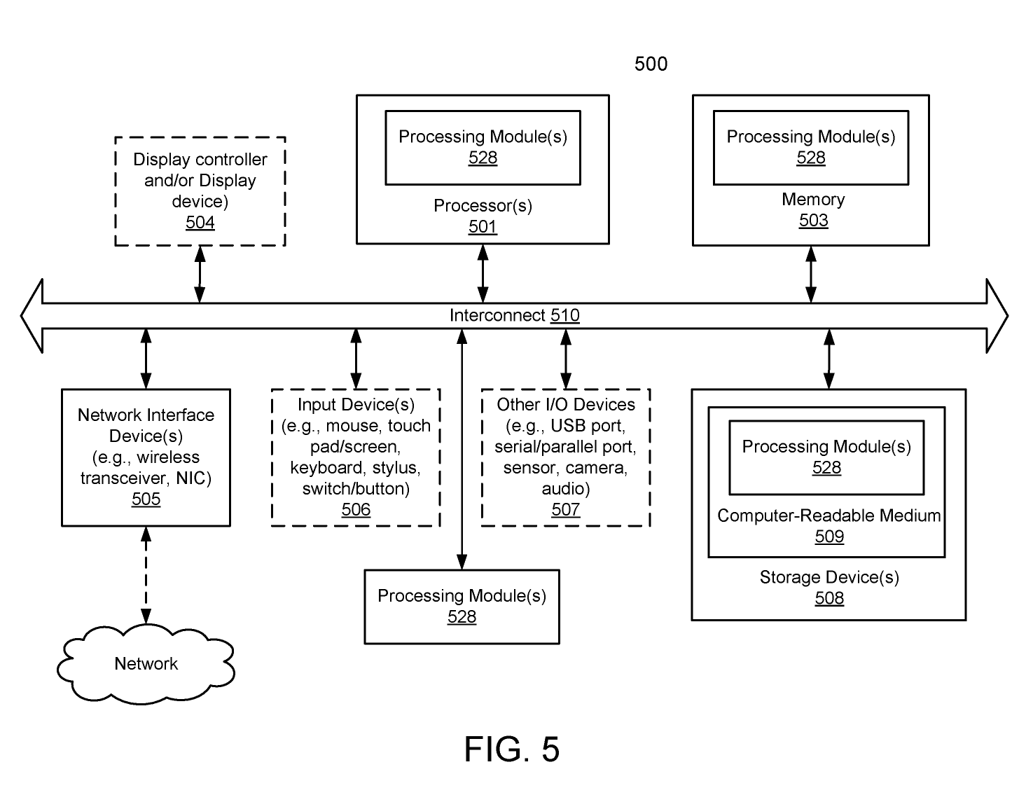

Such computer-implemented services may be provided to one or more users of the data processing system 102 and/or to users of other devices 103 (e.g., via the users of other devices 103 requesting such computer-implemented services from the data processing system 102). Conversely, the other devices 103 may also provide computer-implemented services to the data processing system 102. In embodiments, any of the data processing system 102 and the other devices 103 may implemented as a computing device (e.g., computing device of FIG. 5)

To provide the computer-implemented services, the system of FIG. 1 may include any number of the data processing system 102 and the other devices 103. Data processing system 102 and the other devices 103 may provide the computer-implemented services to their respective users and/or to other devices (not shown). Data processing system 102 and the other devices 103 may provide similar and/or different computer-implemented services. Data processing system 102 and the other devices 103 may also be organized in one or more deployments (e.g., server farms, remote storage environments, Cloud-RAN deployments, or the like) to collectively provide the computer-implemented services.

To provide the computer-implemented services, data processing systems 102A-102N may include various hardware components (e.g., processors, memory modules, storage devices, peripheral devices, etc.) and host various software components (e.g., operating systems, application, startup managers such as basic input-output systems, etc.). These hardware and software components (discussed in more detail below in FIG. 2A) may provide the computer-implemented services via their operation.

The software components may be implemented using various types of services. For example, each data processing system of the data processing systems 102A-102N may host various services that provide the computer-implemented service (e.g., application services) and/or that manage the operation of these services (e.g., management services). The aggregate (e.g., combination) of the management and application services may be a complete service that provide desired functionalities.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and/or types of communication protocols (e.g., such as the internet protocol).

While illustrated in FIG. 1 as including a limited number of specific components, a system in accordance with an embodiment may include fewer, additional, and/or different components than those illustrated therein.

Turning to FIG. 2A, a diagram illustrating an example data processing system 240 in accordance with an embodiment is shown. The data processing system 240 shown in FIG. 2A may be similar to data processing system 102 shown in FIG. 1.

To provide computer-implemented services, data processing system 240 may include any quantity of hardware resources 250. Hardware resources 250 may be in-band hardware components, and may include a processor (e.g., as part of a motherboard of the data processing system 240) operably coupled to memory, storage, and/or other hardware components (e.g., thermistors, on-board thermistors, other types of sensors, fans, or the like). In some embodiments, all or a portion of the hardware resources 250 may make up and be packaged within a single SoC IC (e.g., an SoC IC adapted from an SoC device). For example, the SoC IC may be implemented in the form of a single chip containing all or a portion of the hardware resources 250. The single chip making up the SoC IC may have input and output ports that connect the hardware resources 250 making up the SoC IC to other components of the data processing system 240. Additionally, the SoC IC may, for example, be implemented as the motherboard of the data processing system 240. In embodiments, the SoC IC may be an SoC IC adapted from an SoC device that is originally designed to be capable of providing only passive cooling (e.g., through throttling of the processor). For example, the SoC IC may be an SoC IC adapted from a smartphone device that uses the SoC IC as a motherboard.

In embodiments, the processor of the SoC IC may be a main processor of the data processing system 240. This main processor may host various management entities such as operating systems (OS), drivers (e.g., OS-based and non-OS based drivers), network stacks, and/or other software entities that provide various management functionalities. For example, the OS and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 250 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 270 to a communication component, which may then send the packaged communication (in a yet further packaged form, in some embodiments, with various layers of encapsulation being added depending on the network environment outside of data processing system 240) to another device via any number of intermediate networks (e.g., via wired/wireless channels 276 that are part of the networks).

To reduce the likelihood of the applications and/or other in-band entities from being indirectly compromised, data processing system 240 may include management controller 252 and network module 260. Each of these components of data processing system 240 is discussed below.

Management controller 252 may be implemented, for example, using a system on a chip or other type of independently operating computing device (e.g., a microcontroller or the like that is independent from the in-band components, such as hardware resources 250 of a host data processing system 240). Management controller 252 may provide various management functionalities for data processing system 240. For example, management controller 252 may monitor various ongoing processes performed by the in-band components, may manage power distribution, thermal management, and/or may perform other functions for managing data processing system 240. In some embodiments, the management controller 252 may act as the embedded controller of the data processing system 240. In some embodiments, the management controller 252 may be the sole embedded controller of the data processing system 240 (e.g., there is no separate embedded controller as part of the hardware resources 250).

In embodiments, the management controller 252 may be implemented as an embedded controller (e.g., 290 of FIG. 2B) with separate memory (e.g., random access memory (RAM)) from that of the main processor. The embedded controller may also operate independently from the main processor (e.g., using its own secondary and independent processor) and perform independent functions such as, but not limited to: (i) receiving and processing signals from a keyboard or other input devices of the data processing system 240; (ii) retrieving thermal measurements (e.g., thermal information) from various components of the data processing system (e.g., from the SoC), from one or more thermal sensors installed within the data processing system 240, or the like); (iii) using the thermal measurements to control one or more fans installed within the data processing system 240 and/or to throttle the main processor of the SoC; or the like.

Furthermore, to provide its functionalities, management controller 252 may be operably connected to various components via sideband channels 274 (in FIG. 2A, a limited number of sideband channels are included for illustrative purposes, it will be appreciated that management controller 252 may communicate with other components via any number of sideband channels). The sideband channels may be implemented using separate physical channels, and/or with a logical channel overlay over existing physical channels (e.g., logical division of in-band channels). The sideband channels may allow management controller 252 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 250, management controller 252 may enable information from other devices to be provided to the application without traversing the network stack and/or management entities of hardware resources 250. To do so, the other devices may direct communications including the information to management controller 252.

Management controller 252 may then, for example, send the information via sideband channels 274 to hardware resources 250 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 252 may be operably connected to communication components of data processing system 240 via separate channels (e.g., 272) from the in-band components, and may implement or otherwise utilize a distinct and independent network stack (e.g., TCP/IP). Consequently, management controller 252 may communicate with other devices independently of any of the in-band components (e.g., does not rely on any hosted software, hardware components, etc.). Accordingly, compromise of any of hardware resources 250 and hosted components may not result in indirect compromise of any management controller 252, and entities hosted by management controller 252.

To facilitate communication with other devices, data processing system 240 may include network module 260. Network module 260 may provide communication services for in-band components and out-of-band components (e.g., management controller 252) of data processing system. To do so, network module 260 may include traffic manager 262 and interfaces 264.

Traffic manager 262 may include functionality to (i) discriminate traffic directed to various network endpoints advertised by data processing system 240, and (ii) forward the traffic to/from the entities associated with the different network endpoints. For example, to facilitate communications with other devices, network module 260 may advertise different network endpoints (e.g., different media access control address/internet protocol addresses) for the in-band components and out-of-band components. Thus, other entities may address communications to these different network endpoints. When such communications are received by network module 260, traffic manager 262 may discriminate and direct the communications accordingly (e.g., over channel 270 or channel 272, in the example shown in FIG. 2A, it will be appreciated that network module 260 may discriminate traffic directed to any number of data units and direct it accordingly over any number of channels).

Accordingly, traffic directed to management controller 252 may never flow through any of the in-band components. Likewise, outbound traffic from the out-of-band component may never flow through the in-band components.

Thus, if in-band components of data processing system 240 are unsecured and/or compromised (e.g., by a malicious party), then the computing instructions sent using out-of-band components and via out-of-band communication channels may be less likely to be intercepted and/or modified (e.g., by the malicious party), and the operation of data processing system 240 may be more likely to be updated according to its reported location.

To support inbound and outbound traffic, network module 260 may include any number of interfaces 264. Interfaces 264 may be implemented using any number and type of communication devices which may each provide wired and/or wireless communication functionality. For example, interfaces 264 may include a wireless wide area network (WWAN) card, a Wi-Fi card, a wireless local area network card, a wired local area network card, an optical communication card, and/or other types of communication components. These components may support any number of wired/wireless channels 276.

Thus, from the perspective of an external device, the in-band components and out-of-band components of data processing system 240 may appear to be two independent network entities, that may be independently addressable and/or otherwise unrelated to one another.

To facilitate management of data processing system 240 over time, hardware resources 250, management controller 252 and/or network module 260 may be positioned in separately controllable power domains. By being positioned in these separate power domains, different subsets of these components may remain powered while other subsets are unpowered.

For example, management controller 252 and network module 260 may remain powered while hardware resources 250 is unpowered. Consequently, management controller 252 may remain able to communicate with other devices even while hardware resources 250 are inactive. Similarly, management controller 252 may perform various actions while hardware resources 250 are not powered and/or are otherwise inoperable, unable to cooperatively perform various process, are compromised, and/or are unavailable for other reasons. Therefore, if hardware resources 250 become unavailable (e.g., due to being unpowered), then out-of-band components may remain powered, allowing network module 260 to continue to generate location data for data processing system 240.

To implement the separate power domains, data processing system 240 may include a power source (e.g., 280) that separately supplies power to power rails (e.g., power rail 284, power rail 286) that power the respective power domains. Power from the power source (e.g., a power supply, battery, etc.) may be selectively provided to the separate power rails to selectively power the different power domains. A power manager (e.g., 282) that may manage power from power source 280 may be supplied to the power rails. Management controller 252 may cooperate with power manager 282 to manage supply of power to these power domains.

In FIG. 2A, an example implementation of separate power domains using power rails 284-286 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

Turning now to FIG. 2B, FIG. 2B shows another example of the data processing system 240 shown in FIG. 2A. In particular, FIG. 2B shows an abridged (e.g., simplified) version of the data processing system 240 with certain components visually removed for simplicity. Said another way, although not shown in FIG. 2B, the data processing system 240 of FIG. 2B still includes all of the components shown in FIG. 2A.

As shown in FIG. 2B, data processing system 240 includes an embedded controller 290, a fan 292, and an SOC IC 294 having a power management circuit 296 and an application digital signal processor (ADSP) 298. Each of these components will be described below.

In embodiments, the embedded controller 290 may be implemented as the management controller 252 discussed above in reference to FIG. 2A. The fan 292 may be a computer fan with an active motor that spins a fan blade of the fan 292. In embodiments, the data processing system 240 may have any number of the fan 292. Additionally, the fan 292 (namely the motor and the fan control circuit connected to the motor) may be controlled directly by the embedded controller 290 (e.g., by fan control instructions received in the form of signals transmitted from the embedded controller).

In embodiments the SoC IC 294 may include all or a portion of hardware resources 250 discussed above in reference to FIG. 2A (e.g., in the form of a motherboard of the data processing system 240). The SoC IC 294 may be adapted from an SoC device that does not have the capacity (and/or not originally designed) to include the fan 292 and the embedded controller 290. For example, the SoC IC 294 may be an SoC IC of a mobile phone or a tablet computer. Additionally, the SoC IC 294 is originally designed to be capable of providing only passive cooling (of a data processing system) through throttling of a processor (e.g., the main processor of data processing system 240).

Furthermore, in embodiments, the SoC IC 294 comprises an advanced reduced instruction set computer machines (ARM) based processor as the processor, and is not configured to run an x86 architecture/solution.

In embodiments, the SoC IC 294 may include one or multiple ones of a power management circuit 296. The power management circuit 296 may be a power management integrated circuit (PMIC) installed on the SoC IC 294. The PMIC may be directly connected (e.g., directly soldered) to the one or more thermal sensors of the data processing system 240 (or to the traces leading to the one or more thermal sensors on a PCB having the SoC IC 294 and the one or more thermal sensors).

In embodiments, the SoC IC 294 may further include an application digital signal processor (ADSP) 298. The ADSP 298 may be configured using hardware (e.g., as a microchip/microprocessor within the SoC IC package), software/firmware, or a combination or both. In embodiments, the ADSP 298 may be separate from the SoC IC 294 (e.g., its own independent components within the data processing system 240.

Additionally, the ADSP 298 may be configured to act as the liaison between the power management circuit 296 and the embedded controller 290. In particular, without the ADSP 298, the embedded controller 290 is unable to communicate with the SoC IC 294 to obtain any thermal information (e.g., thermal measurements indicative of a system temperature of the data processing system 240 and/or indicative of a temperature measured by any one of the one or more thermal sensors of the data processing system 240).

In embodiments, the ADSP 298 may be directly connected to the embedded controller 290 using an inter-integrated circuit (I2C)/improved inter-integrated circuit (I3C) interface/link. The I2C/I3C interface/link may be a physical or virtual interface/link. The I2C/I3C interface/link may be an out of band (OOB) communication channel between the SoC IC 294 and the embedded controller 290. In embodiments, a platform environmental control interface (PECI) does not exist between the embedded controller 290 and the SoC IC 294 that would allow the embedded controller 290 to directly communicate with and retrieve the thermal information from the SoC IC 294.

In embodiments, the ADSP 298 may be configured to run (e.g., turned on) as soon as the data processing system 240 is turned on (namely, during and after a pre-boot stage of the data processing system 240). In embodiments, the ADSP 298 may be configured, when it is turned on, to retrieve thermal information from the power management circuit 296. The ADSP 298 may alternatively be implemented as an SoC-CP capable of providing the same functions discussed above.

By instantiating and utilizing the ADSP 298, physical duplication of the thermal sensors of the data processing system 240 is advantageously avoided since the embedded controller 290 can now receive the measurements from these thermal sensors from the ADSP 298 instead of directly from the thermal sensors.

To further clarify embodiments disclosed herein, a data flow diagram in accordance with one or more embodiments disclosed herein is shown in FIG. 3. In these diagrams, flows of data and processing of data are illustrated using different sets of shapes. A first set of shapes (e.g., 300, 302, etc.) is used to represent data structures (e.g., files, data packets, or the like), a second set of shapes (e.g., 290, 292, 294, etc.) is used to represent the components (e.g., the devices, hardware and/or software components, or the like discussed above in reference to FIGS. 1-2B) that perform one or more processes using the information included in the first set of shapes.

As shown in FIG. 3, system temperature 300 may be obtained (e.g., reported to, retrieved by, or the like) by the power management circuit 296 from any one or all of the one or more thermal sensors of the data processing system 240. In embodiments, the system temperature 300 may be indicative of a temperature of the SoC IC 294 of the data processing system 240 and may be a value derived from temperature measurements from one or more of the thermal sensors. System temperature 300 may also be include temperatures of other components (e.g., the network module 260, the power source 280, or the like) of the data processing system 240. Said another way, the system temperature 300 may include any type of temperature data collected by any or all of the thermal sensors of the data processing system 240.

The system temperature 300 may be obtained by the ADSP 298 from the power management circuit 296. Once obtained by the ADSP 298, the ADSP 298 may provide the system temperature 300 to the embedded controller 290 via a communication interface 310.

In embodiments, the communication interface 310 may be a physical or virtual I2C/I3C interface/link that connects the embedded controller 290 directly to the SoC IC 294 (namely, to the ADSP 298 of the SOC IC 294).

In embodiments, although the ADSP 298 is shown in FIG. 3 as being part of the SoC IC 294, the ADSP 298 does not have to be part of the SoC IC 294 and can be its own separate component without departing from the scope of embodiments disclosed herein.

Upon receiving the system temperature 300, the embedded controller 290 may use the system temperature 300 to determine (e.g., using a linear fan control thermal framework, using a thermal fan control table including pulse width modulation (PWM)/revolutions per minute (RPM) values associated with various measured temperatures, or the like ) whether to: (i) generate fan control instructions to cause the fan 292 to run and blow hot/warm air out of the data processing system 240; or (ii) generate throttling instructions for the SoC IC (namely, for the main processor of the data processing system 240 installed within the SoC IC 294) to perform throttling to cool down the data processing system 240.

In particular, in a first example of embodiments disclosed herein, assume for this first example that the data processing system 240 is in a pre-boot stage (e.g., in UEFI mode) (also referred to herein as a “startup process”). During this UEFI mode (where the operating system has not started up yet and is not available), further assume that the system temperature 300 (e.g., Tj of the SoC IC 294) has exceeded a predetermined system temperature threshold (e.g., SoC IC 294 is overheating). The system temperature 300 may be detected by power management circuit 296 and subsequently communicated to the embedded controller 290 through ADSP 298. The embedded controller 290 may use the obtained system temperature 300 to generate fan control instructions to cause one or more of the fan 292 to cool (in an active cooling manner) the overheating SoC IC 294.

As a result, in this first example, the data processing system 240 (namely, the overheating SoC IC 294) may advantageously be cooled using active cooling techniques during a pre-boot stage while utilizing components (e.g., the SoC IC, on-board thermistors, and the like) from a thermal architecture that is originally only capable of providing passive cooling only once the OS is fully started up and operational.

As a second example of embodiments disclosed herein, assume for this example all of the same conditions as in the first example. Further assume now that the active cooling provided by the fan 292 is not enough to cool the data processing system 240 (namely, the SoC IC 294) to drop below the predetermined system temperature threshold. While still in the pre-boot state (e.g., UEFI mode), the embedded controller 290 may generate throttling instructions to cause throttling (e.g., in the form of system level throttling instead of OS level throttling that requires OS-drivers) of the main processor on the SoC IC 294 to further cool the data processing system 240 alongside the fan cooling. This advantageously provided the data processing system 240 with both active and passive cooling during the pre-boot stage.

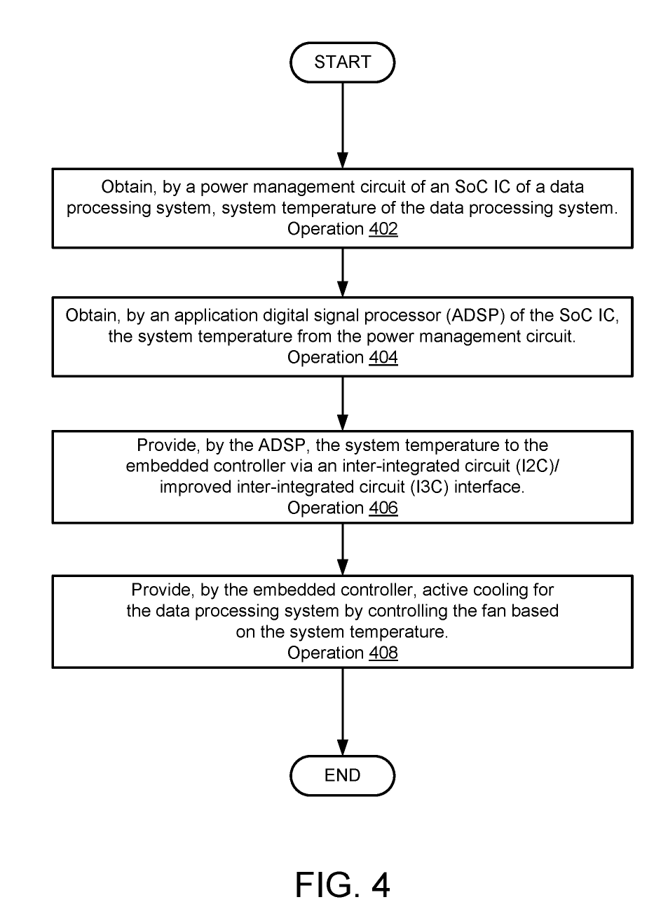

As discussed above, the components of FIGS. 1-3 may perform various methods for cooling (e.g., providing system temperature control for) a data processing system. FIG. 4 illustrates an example method that may be performed by the components of FIGS. 1-2B. For example, any of the data processing system 102, and/or the other devices 103 shown in FIG. 1 may include components (e.g., shown in FIGS. 2A-2B) that are capable of performing all or a portion of the method of FIG. 4. In the diagram discussed below and shown in FIG. 4, any of the operations may be repeated, performed in different orders, and/or performed in parallel with or in a partially overlapping in time manner with other operations.

In Operation 402 of FIG. 4, and as discussed above in reference to FIGS. 2B-3, a power management circuit of an SoC IC of a data processing system may obtain system temperature of the data processing system from one or more thermal sensors installed within the data processing system.

In embodiments, the power management circuit is incapable of communicating directly with an embedded controller of the data processing system. In embodiments, the data processing system may include one or more thermal sensors that measure the system temperature, and, among all components making up the data processing system, only the power management circuit (of the SoC IC) is in connection and able to directly receive the system temperature measured by the one or more thermal sensors.

In Operation 404, and as discussed above in reference to FIGS. 2B-3, an ADSP of the SoC IC may obtain the system temperature from the power management circuit.

In embodiments, among all of the components making up the data processing system, only the ADSP may directly retrieve the system temperature from the power management circuit. Said another way, without the ADSP, the SoC IC alone is incapable of providing active cooling for the data processing system using the embedded controller and the fan. The ADSP bridges the legacy hardware and firmware of the SoC IC with that of the embedded controller such that the SoC IC can be adapted straight from a smartphone device (without any changes to the legacy hardware and firmware of the SoC IC), or other similar device only capable of passive cooling through processor throttling, into the data processing system to start working with the embedded controller to also provide active cooling (e.g., using the fan) alongside the passive cooling.

In Operation 406, and as discussed above in reference to FIGS. 2B-3, the ADSP may provide the system temperature to the embedded controller via an I2C/I3C interface/link directly connecting the SoC IC 294 to the embedded controller. In embodiments, the I2C/I3C link/interface may be a physical or virtual link.

In embodiments, among all of the components making up the data processing system, only the ADSP is able to provide the system temperature to the embedded controller. Said another way, the embedded controller is unable to retrieve the system temperature (from any other component of the data processing system) without aid from the ADSP.

In Operation 408, and as discussed above in reference to FIGS. 2B-3, the embedded controller may provide active cooling for the data processing system by controlling the fan using the system temperature received from the ADSP.

The method may end following operation 408.

Any of the components illustrated in FIGS. 1-4 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. However, it is to be understood that additional components may be present in certain implementations and furthermore, different arrangement of the components shown may occur in other implementations.

System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-508 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like.

More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets.

Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random-access memory (RAM), dynamic RAM (DRAM), synchronous DRAM (SDRAM), static RAM (SRAM), or other types of storage devices. Memory 503 may store information including sequences of instructions that are executed by processor 501, or any other device.

For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows^{®} operating system from Microsoft^{®}, Mac OS^{®}/iOS^{®} from Apple, Android^{®} from Google^{®}, Linux^{®}, Unix^{®}, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs, or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing active cooling using a fan controlled by an embedded controller in a data processing system having a processor installed on a system on a chip (SoC) that is originally only capable of providing passive cooling to the data processing system through throttling of the processor, the method comprising:
obtaining, by a power management circuit of the SoC, system temperature of the data processing system, the power management circuit being incapable of communicating directly with the embedded controller;
obtaining, by an application digital signal processor (ADSP) of the SoC, the system temperature from the power management circuit;
providing, by the ADSP, the system temperature to the embedded controller via an inter-integrated circuit (I2C)/improved inter-integrated circuit (I3C) interface; and
providing, by the embedded controller, active cooling for the data processing system by controlling the fan based on the system temperature, the embedded controller being incapable of obtaining the system temperature without aid from the ADSP.

2. The method of claim 1, wherein the data processing system comprises one or more thermal sensors that measure the system temperature, and, among all components making up the data processing system, only the power management circuit is in connection and able to directly receive the system temperature measured by the one or more thermal sensors.

3. The method of claim 2, wherein, among all of the components making up the data processing system, only the ADSP is able to provide the system temperature to the embedded controller.

4. The method of claim 3, wherein, among all of the components making up the data processing system, only the ADSP is able to directly retrieve the system temperature from the power management circuit, the power management circuit being a power management integrated circuit (PMIC) installed on the SoC.

5. The method of claim 2, wherein the SoC is adapted from a portable computing device not designed to include the embedded controller and the fan, and the SoC is a motherboard of the data processing system.

6. The method of claim 5, wherein the portable computing device being a mobile phone or a tablet computer without a capacity to include the fan and the embedded controller, and the SoC comprises an advanced reduced instruction set computer machines (ARM) based processor as the processor.

7. The method of claim 2, further comprising:
determining, during a startup process of the data processing system and while the embedded controller is already providing the active cooling using the fan, that the system temperature is still above a predetermined threshold; and
causing, by the embedded controller and in response to the determination, throttling of the processor to also provide the passive cooling in addition to providing the active cooling using the fan, the throttling being a system level throttling and provided when operating system (OS) level throttling is not available during the startup process when the OS has not yet completed booting up.

8. A non-transitory machine-readable medium having instructions stored therein, which when executed by a processor, cause the processor to perform operations for providing active cooling using a fan controlled by an embedded controller in a data processing system having a processor installed on a system on a chip (SoC) that is originally only capable of providing passive cooling to the data processing system through throttling of the processor, the operations comprising:
obtaining, by a power management circuit of the SoC, system temperature of the data processing system, the power management circuit being incapable of communicating directly with the embedded controller;
obtaining, by an application digital signal processor (ADSP) of the SoC, the system temperature from the power management circuit;
providing, by the ADSP, the system temperature to the embedded controller via an inter-integrated circuit (I2C)/improved inter-integrated circuit (I3C) interface; and
providing, by the embedded controller, active cooling for the data processing system by controlling the fan based on the system temperature, the embedded controller being incapable of obtaining the system temperature without aid from the ADSP.

9. The non-transitory machine-readable medium of claim 8, wherein the data processing system comprises one or more thermal sensors that measure the system temperature, and, among all components making up the data processing system, only the power management circuit is in connection and able to directly receive the system temperature measured by the one or more thermal sensors.

10. The non-transitory machine-readable medium of claim 9, wherein, among all of the components making up the data processing system, only the ADSP is able to provide the system temperature to the embedded controller.

11. The non-transitory machine-readable medium of claim 10, wherein, among all of the components making up the data processing system, only the ADSP is able to directly retrieve the system temperature from the power management circuit, the power management circuit being a power management integrated circuit (PMIC) installed on the SoC.

12. The non-transitory machine-readable medium of claim 9, wherein the SoC is adapted from a portable computing device not designed to include the embedded controller and the fan.

13. The non-transitory machine-readable medium of claim 12, wherein the portable computing device being a mobile phone or a tablet computer without a capacity to include the fan and the embedded controller, and the SoC comprises an advanced reduced instruction set computer machines (ARM) based processor as the processor.

14. The non-transitory machine-readable medium of claim 8, wherein the operations further comprise:
determining, during a startup process of the data processing system and while the embedded controller is already providing the active cooling using the fan, that the system temperature is still above a predetermined threshold; and
causing, by the embedded controller and in response to the determination, throttling of the processor to also provide the passive cooling in addition to providing the active cooling using the fan, the throttling being a system level throttling and provided when operating system (OS) level throttling is not available during the startup process when the OS has not yet completed booting up.

15. A data processing system comprising:
a system on a chip (SoC) comprising a processor and memory, wherein the SoC is, without an embedded controller, only capable of providing passive cooling to the data processing system through throttling of the processor;
a fan; and
the embedded controller connected to the fan,
wherein the memory stores instructions that, when executed by the data processing system, causes the data processing system to perform operations for providing the active cooling using the fan and the embedded controller, the operations comprising:
obtaining, by a power management circuit of the SoC, system temperature of the data processing system, the power management circuit being incapable of communicating directly with the embedded controller;
obtaining, by an application digital signal processor (ADSP) of the SoC, the system temperature from the power management circuit;
providing, by the ADSP, the system temperature to the embedded controller via an inter-integrated circuit (I2C)/improved inter-integrated circuit (I3C) interface; and
providing, by the embedded controller, active cooling for the data processing system by controlling the fan based on the system temperature, the embedded controller being incapable of obtaining the system temperature without aid from the ADSP.

16. The data processing system of claim 15, wherein the data processing system comprises one or more thermal sensors that measure the system temperature, and, among all components making up the data processing system, only the power management circuit is in connection and able to directly receive the system temperature measured by the one or more thermal sensors.

17. The data processing system of claim 16, wherein, among all of the components making up the data processing system, only the ADSP is able to provide the system temperature to the embedded controller.

18. The data processing system of claim 17, wherein, among all of the components making up the data processing system, only the ADSP is able to directly retrieve the system temperature from the power management circuit, the power management circuit being a power management integrated circuit (PMIC) installed on the SoC.

19. The data processing system of claim 16, wherein the SoC is adapted from a portable computing device not designed to include the embedded controller and the fan.

20. The data processing system of claim 19, wherein the portable computing device being a mobile phone or a tablet computer without a capacity to include the fan and the embedded controller, and the SoC comprises an advanced reduced instruction set computer machines (ARM) based processor as the processor.
